(19) United States
(12) Patent Application Publication
(10) Pub. No.: US 2010/0167167 A1
(43) Pub. Date: Jul. 1, 2010

(54) SOLID POLYMER ELECTROLYTE, METHOD FOR PRODUCTION THEREOF, AND SOLID POLYMER FUEL CELL

(75) Inventors: Tomohiro Nakano, Aichi (JP); Kohei Hase, Aichi (JP); Gert Dorenbos, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KSISHA, Toyota-shi, Aichi (JP)

(21) Appl. No.: 12/600,845

(22) PCT Filed: May 22, 2008
(86) PCT No.: PCT/JP2008/059854

§ 371 Date: Nov. 19, 2009

(30) Foreign Application Priority Data
May 22, 2007 (JP) 2007-135868

(51) Int. Cl. H01M 8/10

(52) U.S. Cl. 429/493; 429/492

(57) ABSTRACT

The present invention provides a solid polymer electrolyte having a water cluster structure composed of hydrophilic groups and occluded water in a solid polymer electrolyte, characterized in that the water cluster structure difference corresponding to the difference between diameters of the pore and the bottleneck part in the water cluster structure calculated by the dissipative particle dynamics method is 15.4×0.072 nm or less. The solid polymer electrolyte has improved ionic conductivity.

### TECHNICAL FIELD

The present invention relates to a solid polymer electrolyte having excellent ionic conductivity. More specifically, the present invention relates to a solid polymer electrolyte that can be used for fuel cells, water electrolysis, brine electrolysis, oxygen concentrators, humidity sensors, gas sensors, and the like, and method for production thereof. In addition, the present invention relates to a solid polymer electrolyte membrane having excellent ionic conductivity and a solid polymer fuel cell having excellent power generation performance.

### BACKGROUND ART

Hitherto, solid polymer electrolytes have been known as proton conductive electrolytes. Solid polymer electrolytes have electrolyte groups in bond chains of a solid polymer material therein. Electrolyte groups have features allowing strong binding to specific ions and allowing selective permeation of cations or anions. Thus, solid polymer electrolytes are formed into particles, fibers, or membranes and thus used for electrodialysis, diffusion dialysis, cell diaphragms and other applications.

For instance, solid polymer electrolyte membranes obtained by forming solid polymer electrolytes into membranes are used for brine electrolysis, solid polymer fuel cells, and the like. In particular, solid polymer fuel cells have high energy conversion efficiencies and substantially no toxic substances are generated therefrom. Therefore, solid polymer fuel cells have been gaining attention as clean and highly efficient power sources and thus have been actively studied in recent years.

Solid polymer electrolyte membranes include fluorine-containing electrolyte membranes, polysiloxane-based electrolyte membranes and hydrocarbon-based electrolyte membranes.

Some types of fluorine-containing electrolyte membranes have sulfonic acid groups, carboxylic acid groups, or other groups as electrolyte groups. For instance, fluorine-containing sulfonic acid membranes having sulfonic acid groups as electrolyte groups are generally used for solid polymer fuel cells. Such membranes that have been widely used include Nafion (trademark, Du Pont) membranes, Flemion (trademark, Asahi Glass Co., Ltd.) membranes and Aciplex (trademark, Asahi Kasei Corporation) membranes.

The structures of such fluorine-containing sulfonic acid membranes are maintained based on crystalline properties of perfluoroalkylene chains. However, since the structures are non-crosslinking structures, electrolyte groups of side chains have high degrees of freedom. Therefore, strongly hydrophobic main chain portions and hydrophilic electrolyte groups coexist under ionized conditions such that electrolyte groups associate with water molecules in a fluorocarbon matrix so as to form water clusters. In such water cluster structures, spherical clusters (pores) having sizes of approximately several nanometers are sequentially connected via channels (bottleneck parts) having narrow widths of approximately 1 nm.

Similarly, also in polysiloxane-based electrolyte membranes, ion exchange groups serving as hydrophilic groups associate with water molecules such that water clusters are formed.

In addition, protons transfer through the water (cluster water) contained in such a water cluster, diffusing in the water, thereby proton conductivity can be exhibited.

As an aside, when a proton conductive membrane is used as a solid polymer electrolyte membrane for fuel cells, it is desirable to use an electrolyte membrane having high ionic conductance to minimize electric resistance upon power generation as far as possible. The membrane ionic conductance significantly depends on the number of ion exchange groups. A fluorine-based ion exchange resin membrane, whose “dry weight per equivalent weight” (EW) is approximately 950 to 1200, is generally used. A fluorine-based ion exchange resin membrane with dry weight of less than 950 exhibits relatively large ionic conductance. However, such membrane is likely to be dissolved in water or warm water and thus is inferior in terms of durability when used for fuel cells, which has been highly problematic.

In view of the above, JP Patent Publication (Kokai) No. 2002-352819 A discloses a low-EW fluorine-based ion exchange resin membrane that can be used for fuel cells. Specifically, the fluorine-based ion exchange resin membrane is disclosed therein, which has 250 to 940 dry weight per equivalent weight (EW) of an ion exchange group and whose decrease in weight after boiling treatment in water for 8 hours is 5 wt % or less relative to the dry weight of such membrane before boiling treatment.

JP Patent Publication (Kokai) No. 2002-352819 A discloses an ion exchange resin membrane with a relatively small EW. However, it is an ion conductive membrane comprising a conventional perfluorosulfonic acid-based electrolyte and thus intended to be used under humidified conditions. In this case, it has been difficult to increase the operation temperature to 100° C. or above. In addition, although the above document describes that the membrane has an EW of 250 to 940, the actually produced membrane was found to have an EW of 614. The reasons why a membrane with an EW of 600 or less could not be achieved using a perfluorosulfonic acid-based electrolyte are described as follows. The unit having sulfonic acid groups has a large molecular weight. In addition, it is essential to use a copolymer unit comprising, for example, tetra-fluoroethylene having no sulfonic acid groups for polymer synthesis.

Thus, the present inventors invented a polymer electrolyte having a specific main chain skeleton instead of a conventional perfluorosulfonic acid-based electrolyte to provide a novel proton conductive material having a small EW value, excellent properties in terms of proton conductivity and strength under no-humidification conditions or low-moisture conditions, and high thermal and chemical stabilities, which can be readily produced at low costs, so as to realize a fuel cell that can be operated at high temperatures under no-humidification conditions or low moisture conditions.

Specifically, JP Patent Publication (Kokai) No. 2006-114277 A discloses a proton conductive material whose dry weight per equivalent weight (EW) of an ion exchange group is 250 or less and preferably 200 or less. Specifically, it is a proton conductive material having a basic skeleton represented by the following structural formula:

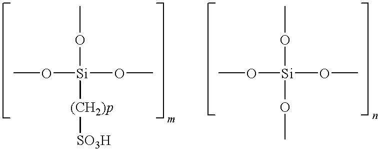

(wherein “p” is 1 to 10 and preferably 1 to 5 (m:n=100:0 to 1:99)).

Such proton conductive material comprising highly-densified proton sources can achieve an EW of 147 under conditions of p=1 and m:n=100:0 in the above structural formula. In addition, the material exhibits excellent thermostability due to siloxane bonds (Si—O). Moreover, the proton conductive material can solve a significant problem in perfluorosulfonic acid-based electrolyte materials such as Nafion (trade name) under no-humidification conditions.

### DISCLOSURE OF THE INVENTION

It is an object of the present invention to further improve the ionic conductivity of a solid polymer electrolyte.

In order to achieve a simplification of a system and an improvement of a output density that are objectives of fuel cells, an electrolyte membrane is required to exhibit performance of a proton conductance of 10⁻² S/cm or more even under stringent conditions such as low-humidity conditions and low-/high-temperature conditions. Currently available fluorine-based electrolyte membranes used in a humidified atmosphere at approximately 80° C. cannot satisfy the above requirement in high-temperature atmospheres and low-humidity atmospheres.

Nafion (trademark), which is a currently available electrolyte membrane material, exhibits high proton conductivity performance in a high-humidity atmosphere. However, the proton conductivity performance deteriorates in a low-humidity atmosphere. Based on the findings obtained by the present inventors, such deterioration is caused by increasing in the number of protons which unnecessarily diffuse in pores, because these pores existing in a portion of the “water cluster structure” prevent the flow of protons.

The present inventors focused on the water cluster structure in an electrolyte membrane, and have found that the ionic conductivity of an electrolyte membrane could be improved by controlling the structure. Then, the present inventors have achieved the present invention.

That is, in a first aspect, the present invention relates to a solid polymer electrolyte having a water cluster structure composed of hydrophilic groups and occluded water therein, characterized in that the water cluster structure difference corresponding to the difference between diameters of the pore and the bottleneck part in the water cluster structure calculated by the dissipative particle dynamics method is 15.4×0.072 nm or less.

FIG. 1 schematically shows a cross section of a water cluster structure composed of hydrophilic groups and occluded water in a solid polymer electrolyte. The water cluster structure has spherically extended pores and narrowed bottleneck parts. In bottleneck parts, protons are transferred without being diffused. On the other hand, protons are diffused three-dimensionally in pores, resulting in delay in proton transfer in a desired direction. In the present invention, the difference between the pore diameter and the bottleneck part diameter in the above water cluster structure is defined.

In the solid polymer electrolyte of the present invention, the average water cluster size of the above water cluster structure defined as follows is preferably 12.7×0.072 nm or less:

Average water cluster size: ΣnR/Σn

(wherein, “R” represents the radius of a single cluster and “n” represents the number of clusters with radius R).

Conventionally known fluorine-containing (perfluoro-based) electrolytes, polysiloxane-based electrolytes and hydrocarbon-based electrolytes can be applied to the polymer electrolyte characterized by the water cluster structure in the present invention. Further preferable molecular structures are searched for by kinetic simulation of bond distances or binding distribution of the ion exchange groups which are hydrophilic groups to the main chain. Accordingly, a polymer electrolyte can be synthesized based on such obtained molecular design.

Among the above examples, for polysiloxane-based electrolytes, the molecular design of the present invention can be readily carried out by utilizing the structure and the synthesis method previously invented by the present inventors. Specifically, such a polysiloxane-based electrolyte is a solid polymer electrolyte having a basic skeleton represented by the following structural formula:

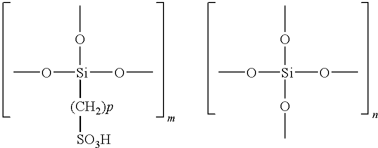

(wherein “p” is 1 to 10 and preferably 1 to 5 (m:n=100:0 to 1:99)).

In a second aspect, the present invention relates to a method for producing a solid polymer electrolyte having a water cluster structure composed of hydrophilic groups and occluded water in a solid polymer electrolyte, wherein the water cluster structure difference corresponding to the difference between diameters of the pore and the bottleneck part in the water cluster structure calculated by the dissipative particle dynamics method is determined to be 15.4×0.072 nm or less by controlling side chain distances between side chains having ion exchange groups and dispersion of the ion exchange groups.

There are some techniques for controlling the distance between side chains having ion exchange groups and dispersion thereof, such as an appropriate adjustment of the addition order of a monomer unit not comprising side chains (herein referred to as a component “b”) and a monomer unit comprising side chains having ion exchange groups (herein referred to as a component “a”) which constitute a polymer electrolyte upon polymer synthesis reaction; and the amounts of the monomers added. Specifically, such technique is described as follows:
(1): The component “a” and the component “b” are uniformly mixed at the beginning of reaction so as to react with each other.
(2): The component “b” is added after the progression of polymerization or condensation polymerization of the component “a,” for a certain period, followed by further polymerization or condensation polymerization.
(3): The component “a” is added after progression of polymerization or condensation polymerization of the component “b,” for a certain period, followed by further polymerization or condensation polymerization.
(4): The component “b” or “a” is added during polymerization or condensation polymerization of the component “a” or “b”, and polymerization or condensation polymerization is continuously performed.

In the above embodiments, polymer electrolytes which have a common ion exchange group number (EW) but are different only in their molecular structures can be produced by adjusting the total amounts of the component “a” and the component “b” to identical levels.

A specific example of the method for producing a solid polymer electrolyte of the present invention is preferably a method for producing a solid polymer electrolyte having a basic skeleton represented by the above structural formula, wherein:

components “a” are synthesized by the steps of replacing mercapto groups contained in mercaptoalkyl-tri-alkoxysilane with sulfonic acid by oxidization, hydrolyzing alkoxy groups contained in tri-alkoxysilanealkylsulfonate, and causing condensation polymerization of silanealkylsulfonate hydroxide;

components “b” obtained in the step of hydrolyzing alkoxy groups contained in tetra-alkoxysilane are appropriately added to the components “a” during synthesis of the components “a” in the step of causing condensation polymerization of silanealkylsulfonate hydroxide; and

condensation polymerization of the above monomer compounds is carried out.

Herein, a sol-gel method is preferably used in the step of causing condensation of the above monomer compounds for a polysiloxane-based electrolyte.

In a third aspect, the present invention relates to a solid polymer electrolyte membrane comprising the above solid polymer electrolyte.

In a forth aspect, the present invention relates to a solid polymer fuel cell comprising the above solid polymer electrolyte.

According to the present invention, a solid polymer electrolyte having excellent ionic conductivity can be provided by defining the difference of the water cluster structure corresponding to the difference between diameters of the pore and the bottleneck part in the water cluster structure, wherein the water cluster structure is composed of hydrophilic groups and occluded water in the solid polymer electrolyte. When such solid polymer electrolyte is used for, for example, a solid polymer electrolyte membrane for a solid polymer fuel cell, a solid polymer fuel cell having excellent proton conductivity even in a poorly humidified condition and exhibiting excellent power generation performance can be obtained.

### BRIEF DESCRIPTION OF THE DRAWINGS

FIG. 1 schematically shows a cross section of a water cluster structure composed of hydrophilic groups and occluded water in a solid polymer electrolyte.

FIG. 2 shows examples of molecular structure models of the polymer electrolyte.

FIG. 3 shows calculation results of distribution sizes of the water cluster structure in molecular structure models 1 to 3. The results were obtained by simulation in accordance with the dissipative particle dynamics method.

FIG. 4 shows a synthesis scheme of silicone-based polymers having three types of molecular structures shown in FIG. 2.

FIG. 5 shows the MSD (mean-square displacement) of molecular structure models 1, 2, and 3 to the time.

FIG. 6 schematically shows effects of a water cluster structure on water molecule diffusion.

FIG. 7 shows the correlation between average water cluster sizes of and diffusion coefficients for water cluster structures.

FIG. 8 shows the correlation between differences of the water cluster structure and the diffusion coefficients.

### BEST MODE FOR CARRYING OUT THE INVENTION

Hereinafter, embodiments of the present invention are described in detail with reference to the drawings.

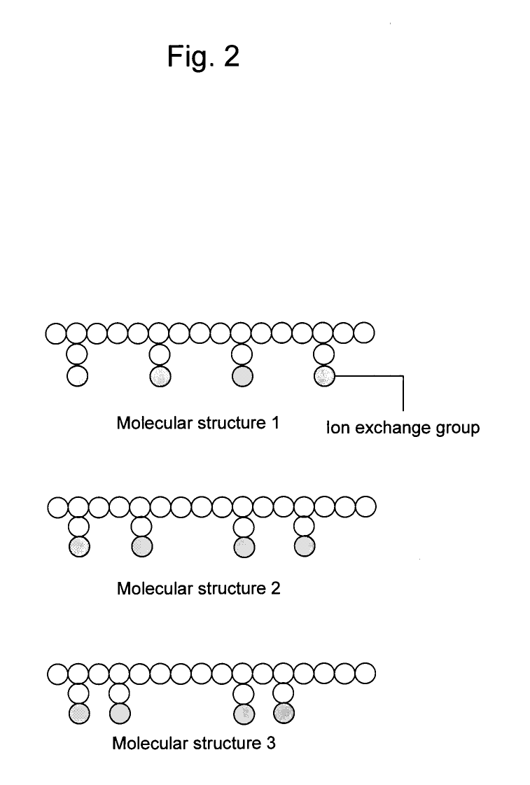

FIG. 2 shows examples of molecular structure models of polymer electrolyte. It is thought that the models 1 to 3 shown in FIG. 2 have a common ion exchange group density (in terms of EW) but are different in their molecular structures (distances between side chains having ion exchange groups and distribution of side chains having ion exchange groups on the main chain).

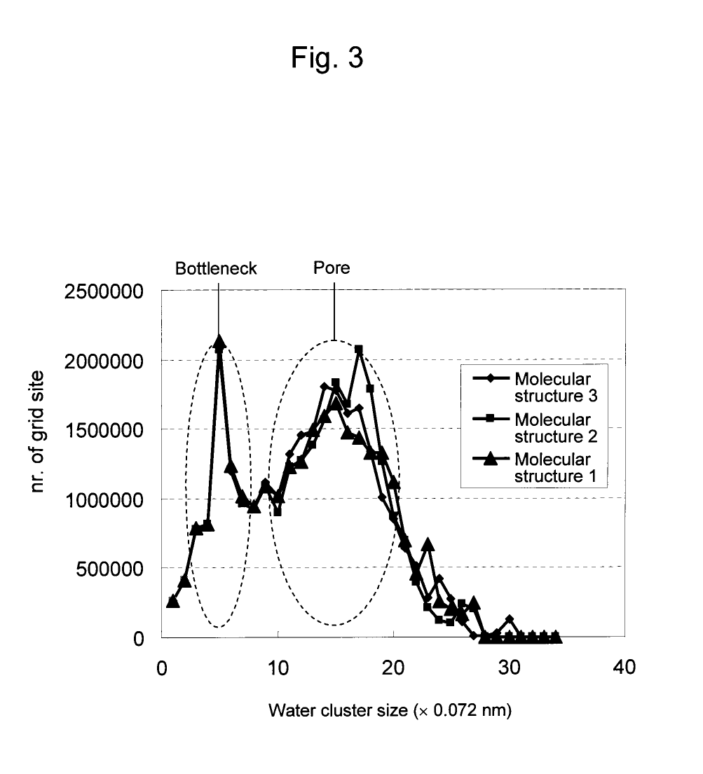

FIG. 3 shows results of distribution of “water cluster structure” sizes in electrolyte membranes separately having molecular structure models 1 to 3, wherein the results were calculated by simulation in accordance with the dissipative particle dynamics method. From the results, it was revealed that two types of the water clusters which have diameters of approximately several nanometers and approximately 10 to 20 nm coexist in each structure.

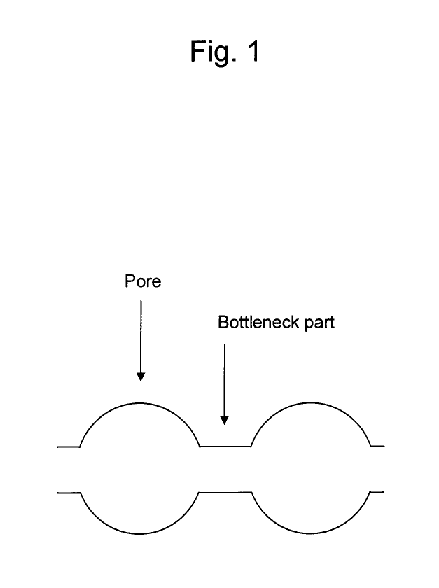

The results in FIG. 3 suggest that polymer electrolyte membranes have small diameter structures (hereinafter referred to as bottleneck parts) and large diameter structures (hereinafter referred to as pores) inside thereof, which can be schematically drawn as in FIG. 1. Based on FIGS. 1 to 3, pore distribution conditions would vary depending on the molecular structure models 1 to 3.

Consequently, it has become possible to change water cluster structures formed even in polymer electrolyte membranes having same number of the ion exchange group (in terms of EW) by changing the molecular structures of the membranes. Proton conductivity would vary depending on water cluster distribution conditions. If distribution of water clusters with large structures (pores) is increased, the number of protons trapped increases, resulting in deterioration in diffusion coefficients. In such case, distances between side chains having ion exchange groups are changed such that an average water cluster structure size and the structural difference (pore size-bottleneck part size) can be decreased. Thus, improved proton conductivity performance can be achieved at a same EW.

Incidentally, as conventional evaluation methods of solid polymer electrolyte, electrolyte membrane performance by measuring conductance using the alternating-current impedance method or NMR relaxation time is known. However, both the methods are intended to indirectly measure water cluster behaviors, and thus it has been impossible to accurately measure the water clustersize and the like by such methods.

Solid polymer electrolytes used in the present invention refer to polymers having electrolyte groups or precursors thereof. Specifically, the polymers include: fluorine-containing polymers whose skeletons are completely fluorinated; fluorine•hydrocarbon-based polymers whose skeletons are partially fluorinated (for example, having bonds such as —CF₂—, —CHF—, and —CFCl—); hydrocarbon-based polymers having fluorine-free polymer skeletons; and silicone-based polymers having silicone skeletons.

More specifically, examples of fluorine-containing polymers include tetra-fluoroethylene polymers, tetra-fluoroethylene-perfluoroalkylvinyl ether copolymers, tetra-fluoroethylene-hexafluoropropylene copolymers, tetra-fluoroethylene-hexa-fluoropropylene-perfluoroalkylvinyl ether copolymers, tetra-fluoroethylene-tri-fluorostyrene copolymers, tetra-fluoroethylene-tri-fluoro styrene-perfluoroalkylvinyl ether copolymers, hexa-fluoropropylene-tri-fluoro styrene copolymers, and hexa-fluoropropylene-tri-fluoro styrene-perfluoroalkylvinyl ether copolymers.

Fluorine hydrocarbon-based polymers include polyvinylidene fluoride, polystyrene-graft-ethylene-tetra-fluoroethylene copolymers, polystyrene-graft-poly-tetra-fluoroethylene, polystyrene-graft-polyvinylidene fluoride, polystyrene-graft-hexafluoropropylene-tetra-fluoroethylene copolymers, and polystyrene-graft-ethylene-hexa-fluoropropylene copolymers.

Hydrocarbon-based polymers include polyether ether ketone, polyether ketone, polysulfone, polyethersulfone, polyimide, polyamide, polyamideimide, polyetherimide, polyphenylene, polyphenylene ether, polycarbonate, polyester, and polyacetal. Such a polymer having a skeleton with aromatic groups is particularly preferable and such a polymer consisting of wholly aromatic groups is further preferable. Also, general purpose resins such as polyethylene, polypropylene, polystyrene and acryl-based resins may be used.

Proton-conductable functional groups may be used as electrolyte groups in solid polymer electrolytes. Specifically, sulfonic acid groups, phosphonic acid groups, carboxylic acid groups, and the like are preferable. In addition, precursors of electrolyte groups may be proton-conductable functional groups obtained by chemical reaction-induced derivatization (e.g., hydrolysis). Specifically, precursors of sulfonic acid groups, precursors of phosphonic acid groups, precursors of carboxylic acid groups, and the like are preferable. In particular, precursors of fluoro groups and metal ion groups such as sodium are preferable. In addition, the solid polymer electrolyte may comprise one type or two or more types of electrolyte group or precursor thereof.

Such solid polymer electrolytes include: a fluorine-containing electrolyte comprising a fluorine-containing polymer and electrolyte groups or precursors thereof; a fluorine-based electrolyte comprising a fluorine•hydrocarbon-based polymer and electrolyte groups or precursors thereof; a hydrocarbon-based electrolyte comprising a hydrocarbon-based polymer and electrolyte groups or precursors thereof; and silicone-based electrolytes. Of these, preferable polymer electrolytes are selected in terms of ease of molecular design and synthesis.

The method for producing a silicone-based electrolyte mentioned by the present inventors is described below. A silicone-based electrolyte is produced with a specific silane material by a sol-gel method. Specifically, a silicone-based electrolyte having a basic skeleton represented by the following structural formula is produced by a sol-gel method using mercaptoalkyl-tri-alkoxysilane and, if necessary, tetra-alkoxysilane as starting materials:

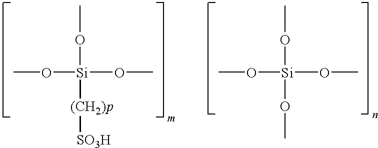

(wherein “p” is 1 to 10 and preferably 1 to 5 (m:n=100:0 to 1:99)).

More specifically, as shown in the reaction scheme described below, the above silicone-based electrolyte can be produced by the steps of

oxidizing mercapto groups contained in mercaptoalkyl-tri-alkoxysilane and, if necessary, tetra-alkoxysilan and thereby replacing the groups with sulfonic acid group;

hydrolyzing alkoxy groups contained in tri-alkoxysilanealkylsulfonate and, if necessary, tetra-alkoxysilane; and

causing condensation of the monomer compounds.

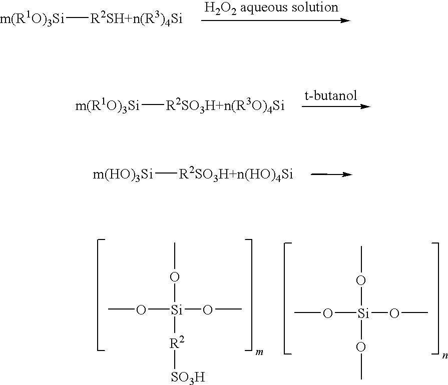

Herein, each of R¹ and R³ denotes an alkyl group and R² denotes an alkylene group.

Hydrogen peroxide and t-butanol used in the step of replacing mercapto groups with sulfonic acid group by oxidization can be readily removed from a reaction system by evaporation. In addition, sulfonic acid groups (—SO₃H) generated in the above step function as catalysts in the step of hydrolyzing alkoxy groups. Accordingly, the present invention is a very rational production method wherein neither reaction by-products nor impurities are generated.

Regarding specific starting materials, 3-mercaptopropyltrimethoxysilane (MePTMS) is a preferable example of the above mercaptoalkyl-tri-alkoxysilane. Also, tetra-methoxysilane (TMOS) is a preferable example of the above tetra-alkoxysilane.

According to the present invention, it is possible to produce a proton conductive material with a desired EW value. A proton conductive material with a desired EW can be produced in a precise manner by appropriately controlling the ratio of “m” to “n” shown in the above reaction scheme, that is to say, the ratio of the above mercaptoalkyl-tri-alkoxysilane to the tetra-alkoxysilane upon preparation. Under conditions of n=0 and p=1, a minimum EW value (obtained when proton sources are highly densified to a maximum extent) of 147 can be obtained. The upper limit of EW is not limited. However, in order to achieve high proton conductance under no-humidification conditions, it is preferably 250 or less.

In addition, the solid polymer electrolyte is preferably in the membrane form. However, it is not particularly limited thereto. A desired form can be selected depending on applications.

When the solid polymer electrolyte of the present invention is used for, for example, a solid polymer electrolyte membrane of a solid polymer fuel cell, the obtained solid polymer electrolyte membrane is superior to conventional electrolyte membranes in terms of conductivity in high-temperature and low-humidity environments, allowing a solid polymer fuel cell to be activated under high-temperature and low-humidity conditions. This results in cell performance improvement.

### Examples

Preferable examples of the present invention are described below.

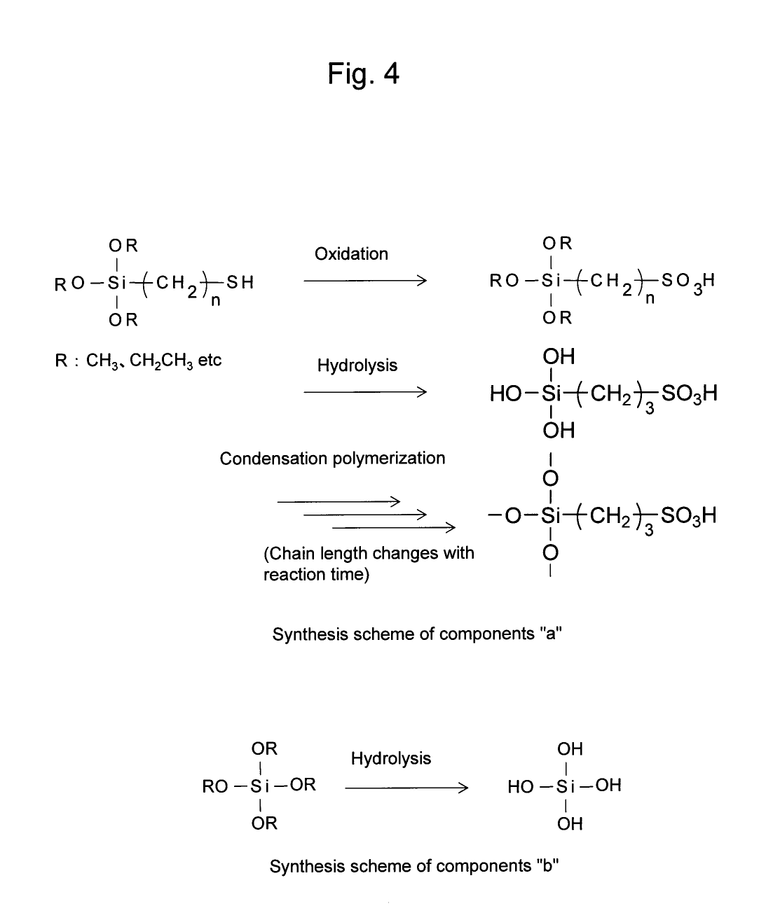

Silicone-based polymers having three types of molecular structures shown in FIG. 2 were synthesized to prepare solid polymer electrolytes. Specifically, in accordance with a sol-gel method using 3-mercaptopropyltrimethoxysilane as a starting material, components “a” and components “b” were synthesized by the synthesis scheme as shown in FIG. 4. Then, the silicone-based polymers having three types of molecular structures shown in FIG. 2 were synthesized by regulating the timing of adding components “b.” Accordingly, polymer electrolytes represented by molecular structure models 1 to 3 shown in FIG. 2 were synthesized. Polymer electrolytes represented by molecular structure models 1 to 3 have a common ion exchange group density (EW). However, they are different in their molecular structures (distances between side chains having ion exchange groups and distribution of side chains having ion exchange groups on the main chain).

Regarding a technique for controlling side chain distances between side chains having ion exchange groups and dispersion of the ion exchange groups, the following are adequately determined for synthesis of polymer electrolytes represented by molecular structure models 1 to 3: the order of addition of monomer units not comprising side chains (herein referred to as components “b”) and monomer units comprising side chains having ion exchange groups (referred to as components “a”) that constitute a polymer electrolyte upon polymer synthesis reaction; and the amount of the monomers added.

Specifically, the molecular structure model 1 can be obtained by uniformly mixing components “a” and components “b” together in advance and allowing them to react in a homogeneous system. The molecular structure models 2 and 3 can be obtained by adding components “b” after the elapse of a certain time period for progression of condensation polymerization of components “a,” followed by reaction in a nonhomogeneous dispersion system for another instance of condensation polymerization. Upon reaction, the total amounts of components “a” and components “b” are predetermined at identical levels. Thus, it has become possible to prepare polymer electrolytes that have a common ion exchange group density (in terms of EW) but are different only in their molecular structures (distances between side chains having ion exchange groups and distribution of side chains having ion exchange groups on the main chain).

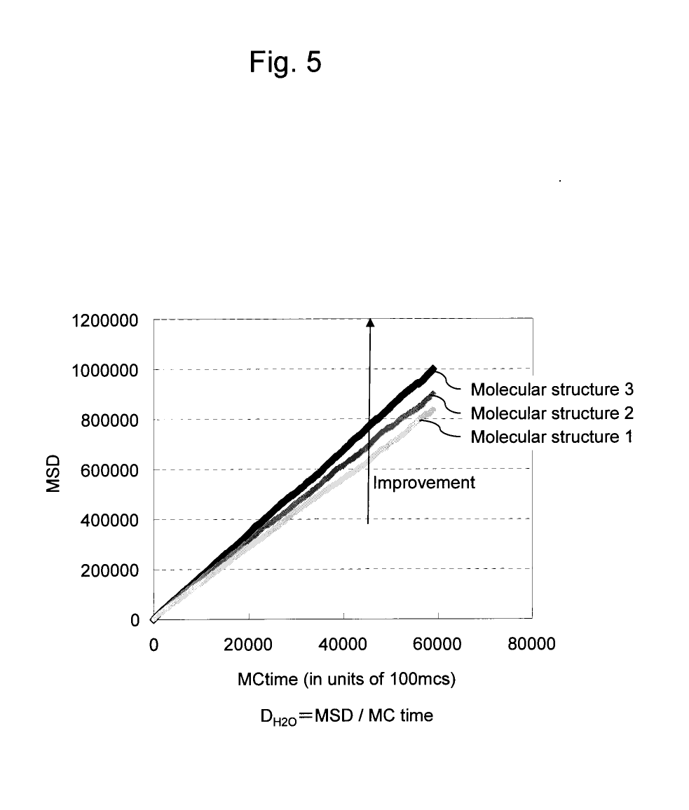

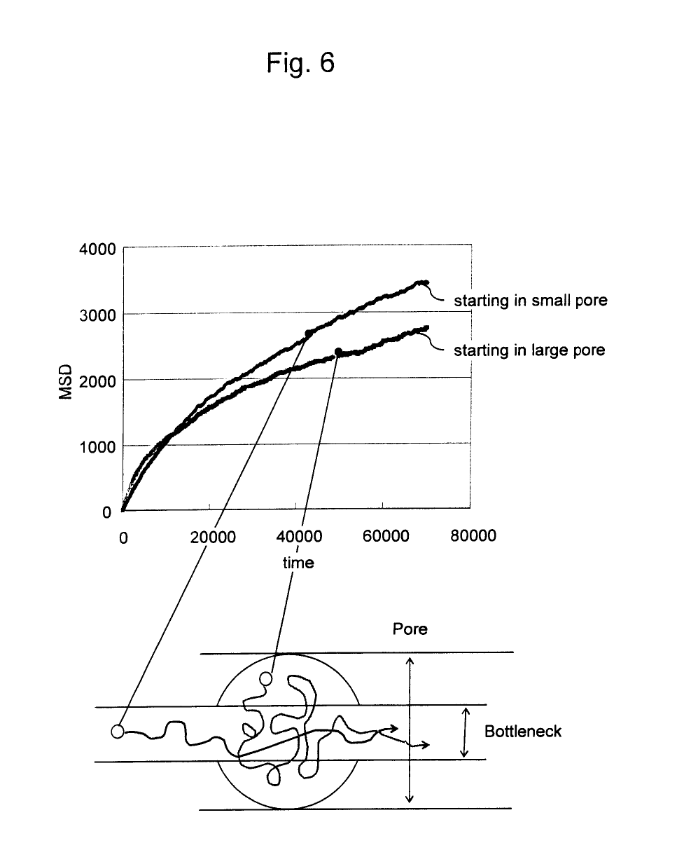

FIG. 5 shows MSD (mean-square displacement) to the time for the molecular structure models 1, 2, and 3. In FIG. 5, a gradient of a graph corresponds to a water diffusion coefficient “D.” The improvement in the diffusion coefficient was observed in the following order: molecular structure model 3>molecular structure model 2>molecular structure model 1. The presence of pores in which water molecules were trapped in a water cluster structure caused diffusion coefficient variations depending on molecular structures. FIG. 6 schematically shows effects of a water cluster structure upon water molecule diffusion. As shown in FIG. 6, it has been found that a lower degree of pore distribution in a water cluster structure results in a greater degree of proton conductivity performance.

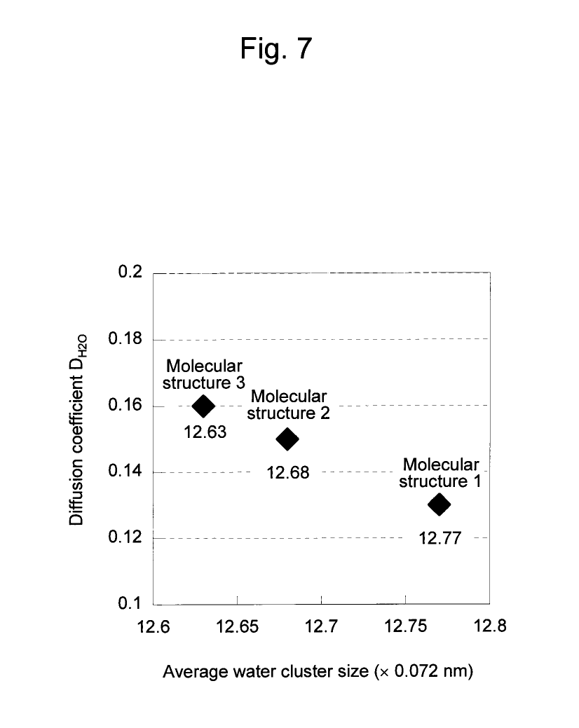

Hence, FIG. 7 shows correlation between the average water cluster size and the diffusion coefficient for a water cluster structure. The results in FIG. 7 clearly indicate that there is a tendency that the diffusion coefficient is further improved with a smaller average water cluster size (average size) for a water cluster structure. That is, the proton conductivity performance of an electrolyte membrane can be further improved as the average water cluster structure size decreases. Specifically, it has been found that a desired diffusion coefficient can be obtained when the average water cluster size for a water cluster structure defined as follows is 12.7×0.072 nm or less:

Average water cluster size: ΣnR/Σn

(wherein “R” represents a single cluster radius and “n” represents the number of clusters with radius R).

Next, differences in water cluster structure sizes shown in FIGS. 1 and 3 were quantified in the manner described below.
(1) Based on FIG. 3, it is assumed that the bottleneck part size is 5×0.7 nm, which corresponds to the maximum distribution.
(2) The average size corresponds to the average value of the bottleneck part size and the pore size and thus the pore size is calculated by the following equation.

Average size=(Bottleneck part size+Pore size)/2

Based on the above, the difference between diameters of the pore and the bottleneck part for the water cluster structure (water cluster structure difference) was obtained.

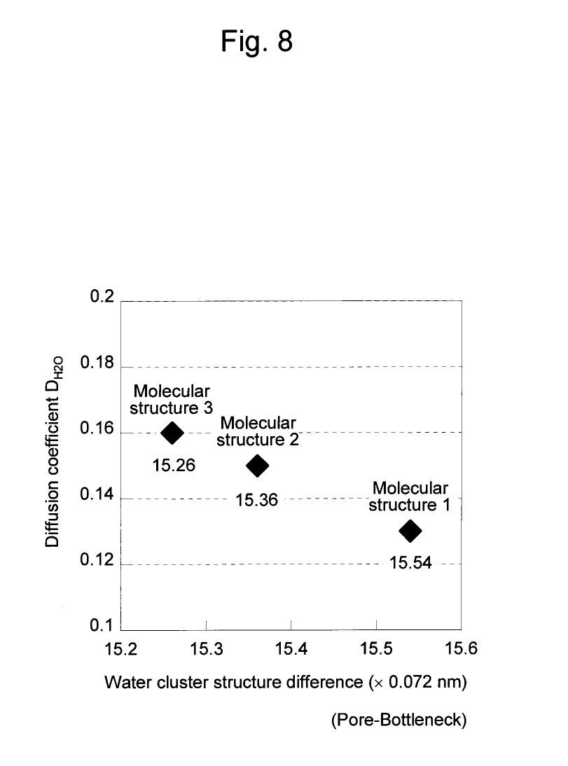

FIG. 8 shows the correlation between water cluster structure differences and diffusion coefficients. The results in FIG. 8 show that a desired diffusion coefficient can be obtained when the water cluster structure difference corresponding to the difference between diameters of the pore and the bottleneck part for a water cluster structure is 15.4×0.072 nm or less.

In the above Examples, silicone-based polymer electrolytes were used in view of ease of molecular design. However, similar results can be achieved using other solid polymer electrolytes such as Nafion (trade name).

### INDUSTRIAL APPLICABILITY

According to the present invention, a solid polymer electrolyte having an excellent ionic conductivity can be provided. When such solid polymer electrolyte is used for, for example, a solid polymer electrolyte membrane for a solid polymer fuel cell, a solid polymer fuel cell having excellent proton conductivity even under poorly humidified conditions, and excellent power generation performance can be obtained. This contributes to practical and widespread use of fuel cells.

1. A solid polymer electrolyte having a water cluster structure composed of hydrophilic groups and occluded water therein, in which the water cluster structure difference corresponding to the difference between diameters of the pore and the bottleneck part in the water cluster structure calculated by the dissipative particle dynamics method is 15.4×0.072 nm or less.

2. The solid polymer electrolyte according to claim 1, in which the average water cluster size of the water cluster structure defined as follows is 12.7×0.072 nm or less:
Average water cluster size: ΣnR/Σn
(wherein “R” represents the radius of a single cluster and “n” represents the number of clusters with radius R).

3. The solid polymer electrolyte according to claim 1, which has a basic skeleton represented by the following structural formula: 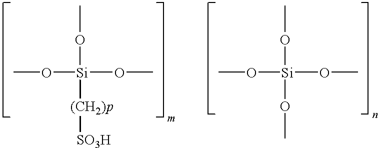
(wherein “p” is 1 to 10 and preferably 1 to 5 (m:n=100:0 to 1:99)).

4. A method for producing a solid polymer electrolyte having a water cluster structure composed of hydrophilic groups and occluded water in a solid polymer electrolyte, wherein the water cluster structure difference corresponding to the difference between diameters of the pore and the bottleneck part in the water cluster structure calculated by the dissipative particle dynamics method is determined to be 15.4×0.072 nm or less by controlling side chain distances between side chains having ion exchange groups and dispersion of the ion exchange groups.

5. The method for producing a solid polymer electrolyte according to claim 4, wherein the average water cluster size of the water cluster structure, defined as follows is 12.7×0.072 nm or less:
Average water cluster size: ΣnR/Σn
(wherein “R” represents the radius of a single cluster and “n” represents the number of clusters with radius R).

6. The method for producing a solid polymer electrolyte according to claim 4, wherein a solid polymer electrolyte having a basic skeleton represented by the structural formula described below is produced in a manner such that:
components “a” are synthesized by the steps of
replacing mercapto groups contained in mercaptoalkyl-tri-alkoxysilane with sulfonic acid by oxidization,
hydrolyzing alkoxy groups contained in tri-alkoxysilanealkylsulfonate, and
causing condensation polymerization of silanealkylsulfonate hydroxide;
components “b” obtained in the step of hydrolyzing alkoxy groups contained in tetra-alkoxysilane are appropriately added to the components “a” during synthesis of the components “a” in the step of causing condensation polymerization of silanealkylsulfonate hydroxide; and
condensation polymerization of the above monomer compounds is carried out: 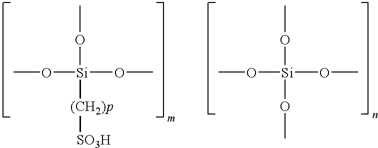
(wherein “p” is 1 to 10 and preferably 1 to 5 (m:n=100:0 to 1:99)).

7. The method for producing a solid polymer electrolyte according to claim 6, wherein the step of causing condensation of the monomer compounds is a sol-gel method.

8. A solid polymer electrolyte membrane comprising the solid polymer electrolyte according to claim 1.

9. A solid polymer fuel cell comprising the solid polymer electrolyte according to claim 1.
